(19) United States
(12) Patent Application Publication
(10) Pub. No.: US 2005/0095570 A1
(43) Pub. Date: May 5, 2005

(54) Method of teaching a technique to a user and method of learning the technique

(75) Inventor: William M. Hathaway, Powell, OH (US)

Correspondence Address: MICHAEL BEST & FRIEDRICH, LLP, 100 E WISCONSIN AVENUE, MILWAUKEE, WI, 53202, US

(73) Assignee: MoreSteam.com LLC, Powell, OH (US)

(21) Appl. No.: 10/976,570

(22) Filed: Oct. 29, 2004

Related U.S. Application Data
(60) Provisional application No. 60/515,240, filed on Oct. 29, 2003.

(51) Int. Cl. G09B 3/00

(52) U.S. Cl. 434/350

(57) ABSTRACT

A method of teaching a technique to a user. The technique includes a body of acts, steps, methods, rules, fundamentals, principles, cannons, etc. attempting to accomplish a desired aim. The method further includes teaching a lesson to a user and providing a computer-based game to the user to be played by the user. The computer-based game supports the teachings of the lesson. Also disclosed are methods of learning the technique.

### RELATED APPLICATIONS

This non-provisional application claims priority to U.S. Provisional Patent Application No. 60/515,240 filed Oct. 27, 2003.

### FIELD OF THE INVENTION

The invention relates to methods of teaching a technique to an individual and methods of learning the technique.

### BACKGROUND

There are multiple ways of teaching a technique, such as a process improvement technique, to an individual or a group of individuals. Example ways include providing instruction to a group of individuals or students in a classroom environment, providing media (e.g., videotapes or DVDs) having instructional content to individuals, or providing instructional content to individuals via a web site. There are multiple ways of supporting the instruction taught to the individuals. For example, a test can be used as a teaching tool or as an assessment to support the teachings taught to the individuals. Additional ways of supporting the instruction taught to individuals are desired.

### SUMMARY

Accordingly, the invention provides, in one embodiment, a method of teaching a technique to a user having a computer. The method includes providing a computer-based lesson to the user. The lesson teaches at least an aspect of the technique. The method also includes providing a computer-based game to the user. The game supports the teachings of the lesson.

In another embodiment, the invention provides a method of learning a technique via a computer. The method includes receiving a computer-based lesson at the computer, learning the lesson at the computer, receiving a computer-based game at the computer, and executing the computer-based game with the computer.

In yet another embodiment, the invention provides a method of teaching a technique to a user. The method includes teaching a lesson to the user, and providing a computer-based game to the user to be played by the user. The game supports the teachings of the lesson and results in stored data when the user plays the game. The method further includes obtaining the data and analyzing the data.

In even yet another embodiment, the invention provides a method of learning a technique. The method includes receiving instruction including a lesson, receiving a scenario for a computer-based game that supports the teachings of the lesson, and playing the game including the scenario.

In another embodiment, the invention provides a method of teaching a technique to a user. The method includes providing a computer-based game to the user to be played by the user. The game results in stored data when the user plays the game. The method further includes obtaining the data, analyzing the data, and creating a lesson based on the data. The lesson includes at least an aspect of the technique.

In another embodiment, the invention provides software adapted to be used by a computer having a processor and memory, the software including a computer-based game which is operable to generate game related data stored on the computer memory. The software also includes a lesson for teaching a technique, the lesson including the steps of obtaining the game related data, analyzing the game related data and including content directed to at least an aspect of the technique using the analyzed data to teach the lesson.

Other features and advantages of the invention will become apparent to those skilled in the art upon review of the following detailed description, claims, and drawings.

### BRIEF DESCRIPTION OF THE DRAWINGS

FIG. 1 is a schematic diagram of a system adapted to provide the invention.

FIG. 2 is a screen print showing a portion of a web page displaying a course syllabus.

FIG. 3 is a screen print showing a web page displaying a portion of a lesson.

### DETAILED DESCRIPTION

Before any aspects of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. The terms “connected,” “coupled,” and “mounted” and variations thereof herein are used broadly and, unless otherwise stated, encompass both direct and indirect connections, couplings, and mountings. In addition, the terms connected and coupled and variations thereof herein are not restricted to physical and mechanical connections or couplings. As used herein the term “computer” is not limited to a device with a single processor, but may encompass multiple computers linked in a system, computers with multiple processors, special purpose devices, computers or special purpose devices with various peripherals and input and output devices, software acting as a computer or server, and combinations of the above. In general, computers accept and process information or data according to instructions (i.e., computer instructions).

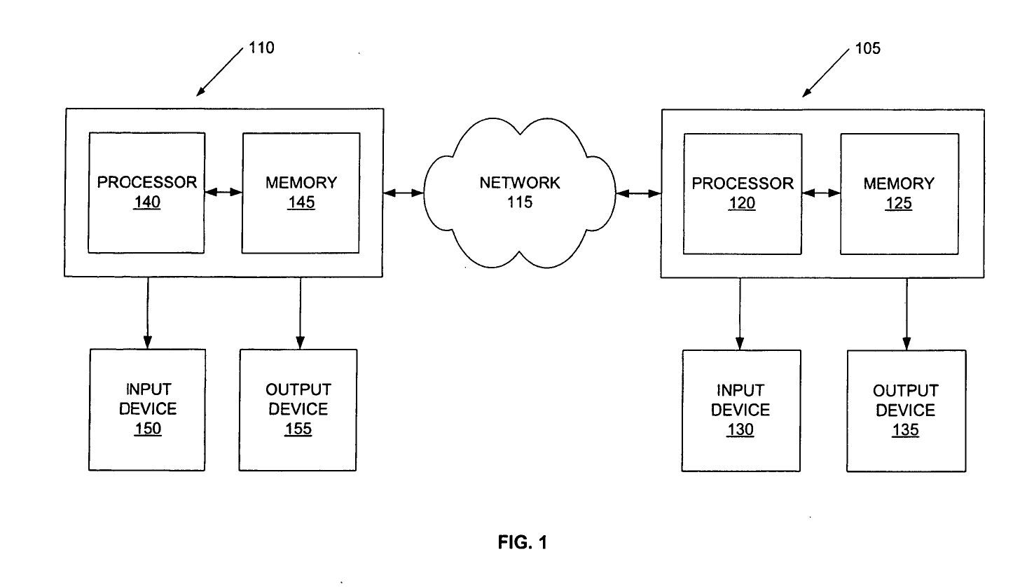

One exemplary system 100 incorporating the invention is schematically shown in FIG. 1. In general, the system 100 includes a first computer 105 (referred to below as the client computer or client) in communication with a second computer 110 (referred to below as the server computer or server) over a network 115. As explained in greater detail below, the system 100 can be used to deliver instructional content to user of the system 100. The system 100 can also be used to deliver a game to the user. The game is used to support the teachings of the instructional content. As described below, the requirements of the system 100 are flexible.

In particular, while only one client 105 and only one server 110 are shown in FIG. 1, the system 100 can include multiple servers 110 clients and multiple clients, 105 the number of clients 105 being limited only by the capacity of the network 115 and the servers 110. The client 105 includes a processor 120, memory 125 (e.g., RAM, program storage, data storage, etc.), and one or more input/output devices 130 and 135 (e.g., disk drive, optical drive, display, printer, touch screen, etc.). Example types of client computers include, but are not limited to, an electronic device capable of accessing the Internet including the World Wide Web (e.g., an Internet appliance), a handheld device, a laptop computer, a desktop computer, etc. Those of ordinary skill in the art will recognize that the terms “processor,” “client computer,” “browser,” “network” and the like are broadly defined and can apply to a wide variety of devices. The client 105 typically includes an operating system adapted to support a graphical user interface (GUI) and adapted to run a browser. The browser may be a web browser such as Netscape Navigator, Microsoft Explorer, Mozilla Firefox or a program with similar functionality that may access information from the server 110. The client 105 receives input from the input device 130 (e.g., a keyboard, a mouse, a CD-ROM, etc.) and communicates outputs to output device 135 (e.g., a display, a printer, a read/write device, etc.). Of course, the input/output devices can include a device that communicates inputs and receives outputs (e.g., a touch screen, a read/write device, etc.) The client 105 also receives inputs and communicates outputs through an auxiliary port 140, such as a USB (universal serial bus) port, a wireless port, or embedded web interface.

The client 105 is connected to the network 115, which can be any local or wide-area network. In one construction of the system 100, the network 115 is the Internet or an intranet that is implemented using Internet protocols. The client 105 is adapted to communicate with the server 110 using Internet protocols such as IP/TCP (Internet Protocol/Transmission Control Protocol).

The server 110 also includes a processor 140, memory 145, one or more input/output devices 150 and 155, and an auxiliary port 160. As will be discussed in more detail below, the server 110 provides a means for remotely teaching a technique to an individual via the client 105. The server 110 includes a server interface, such as a common gateway interface (CGI) or Internet Server Application Programming Interface (ISAPI), and a web site. The web site includes a graphical user interface module, a knowledge base, HTML or XML files, and associated components. The server 110 also includes and is adapted to run a game application that provides a game having a scenario as will be discussed below.

The operation of the invention will be described in connection with the system 100 illustrated by FIG. 1. There are, however, other systems capable of performing the invention. For example and as will be discussed below, not all of the components shown in FIG. 1 are required for some operations of the invention. In particular, the system 100 shown in FIG. 1 communicates content to the user of the system 100 via the network 125 and at least two computers 105 and 110. In other constructions, the content can be delivered or taught to the user by other means. For example, the technique can be taught by providing instruction to one or more individuals in part via the system 100 and in part in a traditional classroom environment and/or providing instruction to one or more individuals on reproducible media. In still other constructions, the technique can be taught by way of instructional content resident on the local computer operated by the user. For example, the lessons can be in the computer's local memory or on a media accessed locally by the client 105 rather than via the network 125.

In use of the system 100, the client 105 accesses the server 110 using a browser. The client 105 may communicate with the server 110 using known transmission standards. Once a connection is made with the server 110, the client 105 receives content from server 110. In one construction, the content includes a web page having text and links to other web pages or files (also collectively referred to as content). Example files include text files, executable files, audio files, video files, and audio/video files.

For one example, the client 105 can access a web site that, among other things, includes instructional content that teaches a technique to a user. As used herein, the term “technique” is broadly defined as a body of acts, steps, methods, rules, fundamentals, principles, cannons, etc. attempting to accomplish a desired aim. The technique is taught to the individual in one or more lessons by organizing the instructional content accordingly. The term “lesson” is broadly defined herein as a piece of instruction or portion of instructional content that teaches a technique or an aspect of the technique. One or more lessons can be grouped in chapters, sections, and/or courses. Instructional content can be provided by a variety of means, including for example text files, executable files, audio files, video files, and audio-video files.

An exemplary web site that provides instructional content for teaching a technique can be found at http://www.moresteam.com, which is provided by Moresteam.com^{SM} LLC of Powell, Ohio. Generally speaking, the http://www.moresteam.com web site provides online instruction for a process improvement technique known as Six Sigma. The lessons provided by the Moresteam.com^{SM} web site include instructional content addressing a variety of topics commonly associated with Six Sigma process improvement techniques. Among those topics are analytical tools for reducing variability in existing products and processes (referred to herein as DMAIC, which stands for define, measure, analyze, improve, and control), and for designing new products and processes (referred to herein as DFSS, which stands for design for Six Sigma). Example steps relating to DFSS include 1) defining the voice of the customer, 2) measuring the output important to the customer, 3) translating the output into internal specifications, 4) determining a design and alternative designs, 5) implementing a design, and 5) evaluating the design. The Moresteam.com^{SM} web site includes multiple courses divided into lessons for teaching the Six Sigma process improvement technique to an individual or group of individuals, both of which are referred to herein as users.

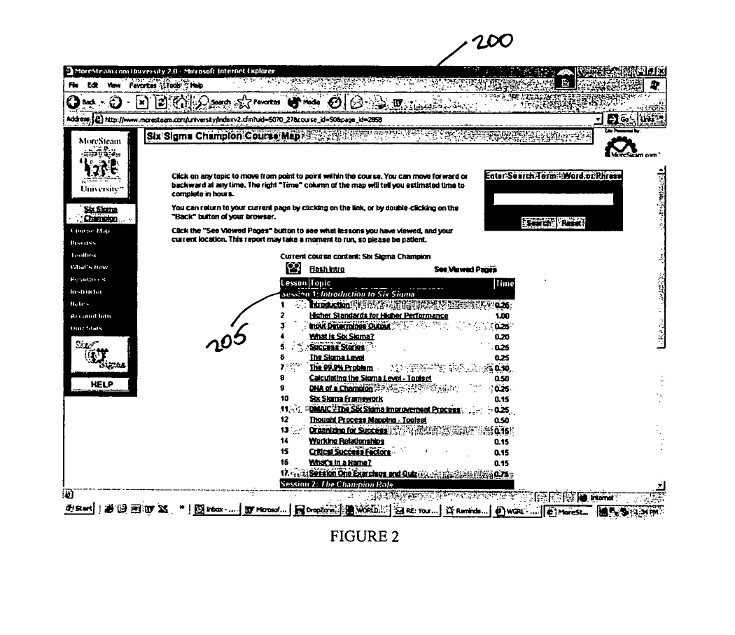

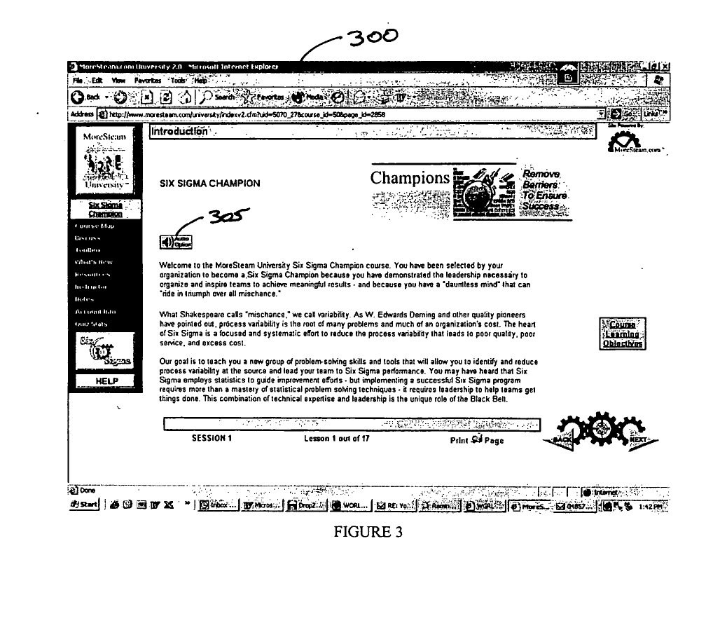

For a more detailed example, FIG. 2 shows a representative web page 200 displaying a course syllabus that can be accessed via http://www.moresteam.com. The course is divided into numerous lessons which are accessible by respective hyper-links. The user can “click” on a lesson to access the instructional content associated with that lesson so as to learn that lesson. For example, if the user clicks on the link “Introduction” 205, then the web site proceeds to the web page 300 shown in FIG. 3. The user can view the text and other content relating to the Introduction lesson and/or obtain an audio file related to the lesson by clicking the button 305. Other instructional content can be provided to the user similarly.

The user of the system 100 can also use the client 105 to receive a game that supports the teachings of the lesson, section, or course. The term “game” is defined herein as an activity undertaken or regarded as a contest, challenge, competition, race, or match involving rivalry, strategy, or struggle. The game has entertainment value independent of its use as an instructional tool, but is also useful as a model or simulation of a process. Generally speaking, one use of a model is to describe a process or series of inter-related processes. A model, or simulation, can be useful in any of a variety of ways. For example, a simulation can be used to vary (either slow or accelerate) the process from real-time. Also, a modeled process can be used to experiment with changes in the process, thus avoiding disruption in the real-time process and avoiding the costs associated with such disruptions. Using an accelerated model of a process also affords the opportunity to sample data in an accelerated manner. When a computer is used to model or simulate processes, the model can be crafted to mimic sophisticated processes having random or chaotic aspects. Of course, with the use of computers also comes great flexibility in providing visual and audio depictions of the modeled process and changes to the process. As applied t learning a technique, the use of a game to support the lessons conveying instructional content is advantageous by providing an experience that engages and entertains the user while also supporting the instructional aspects of the lesson.

As applied to learning Six Sigma techniques, a suitable model or simulation must afford the user the opportunity to identify one or more critical to quality factors of a process. The model should also afford the measurement of the process in terms of the critical to quality factors. The model should also afford the opportunity to vary or control aspects of the process and provide outputs that correspond to the changes made. In effect, for a model to be useful in the context of Six Sigma learning, teaching and assessment, the model must afford the user the opportunity to use or practice the techniques associated with DMAIC approaches to process improvement or the techniques associated with DFSS. For a game to be most useful as support for a lesson teaching a Six Sigma technique, the game should also incorporate a model or simulation.

An exemplary game provided to the user is the strategy game RollerCoaster Tycoon® offered by Atari, Inc. of New York, N.Y. RollerCoaster Tycoon® includes numerous predefined scenarios and affords the user the capability to create new scenarios.

The client 105 obtains a licensed copy of the game, which may be obtained through the web site, and receives a previously created scenario (also referred to herein as a baseline scenario) stored at the server 110. In some constructions, the game parameters are set prior to the user playing the game. This condition of pre-setting the game data is referred to herein as creating a scenario for the user. The scenario can include initial parameters and data intended to test the individual on the previously learned lesson or technique, thereby supporting the teachings of the lesson. Among the features of the game included with the initial parameters and data is customer data. The customer data can be specifically designed with information and data in the form of problems that test whether the user has properly learned the lesson or technique.

For example, RollerCoaster Tycoon® includes simulated customers that patronize a theme park and the facilities created therein. In this example of a simulation or game, the game generates thoughts of each customer at various points of time are stored, thereby creating a log of each user. Also identified with each user are tolerances (e.g., for rides), the amount of money spent by each customer, how the customer feels (e.g., is the customer tired, hungry, thirsty, sick), and other attributes. As a result, the game generates various classifications of data that vary over time, and the user can learn the problems and concerns of one or more customers using data sampling techniques. All of these concerns can be provided to the user before beginning the scenario. For example, in one construction, the user can receive background information and historical data (e.g., a case study with data in spreadsheet form) for the user to use prior to playing the game. The user can then begin the game based on the initial historical data.

Using this information or data provided, the user can begin the simulation or game and execute the simulation using the learned teachings. For example, in RollerCoaster Tycoon® this can include creating one or more rides, concession stands, etc; setting prices; hiring and maintaining support staff; and other actions defined by RollerCoaster Tycoon®. During the game play, the user can query one or more customers. This additional information can be used as a basis for decision-making to further operate/modify the theme park design and/or a roller coaster for use in the theme park. Specifically with respect to Six Sigma techniques, tools learned from the instructional materials can be utilized to assess the operational data generated by the game. Applying those tools and making decisions accordingly in playing the game affords the user the opportunity to observe the outcomes of decisions made using Six Sigma techniques. Therefore, the game or simulation can support the teachings of the lesson.

As a result of game play, the game stores or maintains performance data, typically at the client 105. For example, in RollerCoaster Tycoon®, financial data relating to the theme park is stored at the first computer 105. At some point, the data can be communicated from the client 105 to the server 110. For example, the user can end the game at some specified time and connect to the server 110. The server 110 can use a helping program, which may or may not be part of the game, to access the performance data stored at the client 105. Other methods of providing the data to the second computer 110 are possible.

For example, in RollerCoaster Tycoon®, the user creates and runs a theme park, which can be thought as a product. The theme park includes stands and rides (e.g., a roller coaster), which also can be thought of as products. The status of the theme park, the components of the theme park, the data relating to the theme park (including the rides and stands), and the thoughts, actions, and feelings of the customers can be communicated to the server 110. The data and information received from the client 105 can be analyzed to determine the performance of the user. The resulting analysis can be used to grade the user (i.e., metrics can be used to determine the performance of the user), make an assessment of the user's proficiency in using the learned technique, provide feedback to the user, and/or provide more pointed instruction to the user. It is also envisioned that the analysis of the data can be performed at the client 105.

While the invention has been described in connection with RollerCoaster Tycoon®, the invention is not limited to RollerCoaster Tycoon®. Rather, any game that simulates a desired environment to teach the lesson can be used. In some constructions, it is preferred that the simulated environment includes a business and the customers of the business can be queried to provide information or data to the user.

In one specific operation of the system, a computer-based game is stored at the final computer 105; a user learns at least an aspect of a technique through one or more lessons, which can be taught via a web site or be resident on the computer 105; the user plays the game where the game can include a predefined scenario; data created during the game is stored; the stored data is analyzed for evaluation/assessment or providing further instruction. The order of the just described acts can vary. Prior to and/or during the game, the user can engage in various activities that reflect proficiency in the learned lesson. In the case of a Six Sigma technique lesson, for example, the simulation should afford the user the ability to determine the voice of the customer, measure the output important to the customer, translate the output into internal specifications, determine a design or next step based on the internal specifications, implement the design during the game, and evaluate the design based on the on-going simulation provided by the game.

In another operation of the invention, the game, including the predefined scenario, is provided to the user prior to the teaching of one or more lessons. The user plays the game and data is obtained from the game. Based on the resulting data, the instructor or web site can tailor one or more lessons to the user to better instruct the user. That is, the data obtained from the game can be used to generate the one or more lessons. The user can than play the game, with the same or new scenario, to support the teachings of the lesson.

The system 100 thus provides software modules that adapted to be used by or run on either the client computer 105 or the server 110. The software modules include a computer-based game which is operable to generate game related data to be stored on the computer memory. The modules also include one or more lessons including content of various form for teaching a technique. Preferably, the instructional content includes information relating the play of the play in a manner supporting the teachings of the lesson, either as practice or illustration of the lesson or as an assessment of proficiency of skills conveyed by the lesson. The lesson modules may include information usable to obtain the game related data, analyzing the game related data and can include content directed to at least an aspect of the technique using the analyzed data to teach the lesson.

Various other features and advantages of the invention are set forth in the following claims.

1. A method of teaching a technique to a user having a computer, the method comprising:
providing a computer-based lesson to the user, the lesson teaching at least an aspect of the technique; and
providing a computer-based game to the user, the game supporting the teachings of the lesson.

2. A method as set forth in claim 1 wherein the act of providing a computer-based lesson to the user includes communicating the lesson to the computer.

3. A method as set forth in claim 2 wherein the communication is via the Internet.

4. A method as set forth in claim 1 wherein the act of providing a computer-based lesson includes providing a server executing a web site and communicating content from the server to the computer, the content including the lesson.

5. A method as set forth in claim 4 wherein the content includes at least one of a text file, an executable file, an audio file, a video file, and an audio-video file.

6. A method as set forth in claim 4 wherein the content includes one or more web pages containing at least a portion of the lesson.

7. A method as set forth in claim 1 wherein the act of providing a computer-based game to the user includes communicating the game to the computer.

8. A method as set forth in claim 2 wherein the communication is via the Internet.

9. A method as set forth in claim 1 wherein the act of providing a computer-based game includes providing a server executing a web site and communicating content from the server to the computer, the content including the game.

10. A method as set forth in claim 1 wherein the technique includes a process improvement technique.

11. A method as set forth in claim 1 wherein the technique includes the design for Six Sigma technique.

12. A method of teaching a technique to a user having a computer, the method comprising:
transmitting a computer-based lesson to the computer via the Internet, the lesson teaching at least an aspect of the technique; and
transmitting a computer-based game to the computer via the Internet, the game to support the teachings of the lesson.

13. A method as set forth in claim 12 wherein the method further comprises providing a server executing a web site, and wherein the act of transmitting a computer-based lesson includes transmitting content from the server to the computer, the content including the lesson.

14. A method as set forth in claim 13 wherein the content includes one or more web pages containing at least a portion of the lesson.

15. A method as set forth in claim 13 wherein the content includes at least one of a text file, an executable file, an audio file, a video file, and an audio-video file.

16. A method as set forth in claim 14 wherein the act of transmitting a computer-based game includes transmitting additional content from the server to the computer, the additional content including the game.

17. A method as set forth in claim 12 wherein the technique includes a process improvement technique.

18. A method as set forth in claim 12 wherein the technique includes the design for Six Sigma technique.

19. A method of learning a technique via a computer, the method comprising:
receiving a computer-based lesson at the computer, the lesson teaching at least an aspect of the technique;
learning the lesson at the computer;
receiving a computer-based game at the computer, the game to support the teachings of the lesson; and
executing the computer-based game with the computer.

20. A method as set forth in claim 19 wherein the acts of receiving and executing the computer-based game are after the acts of receiving and learning the computer-based lesson.

21. A method as set forth in claim 19 wherein the method further comprises connecting the computer to the Internet, and wherein the act of receiving a computer-based lesson includes receiving the computer-based lesson at the computer via the Internet.

22. A method as set forth in claim 19 wherein the method further comprises connecting the computer to the Internet, wherein the act of receiving a computer-based lesson includes receiving content from a web site via the Internet, the content including the lesson, and wherein learning the lesson on the computer includes executing the content.

23. A method as set forth in claim 22 wherein the content includes at least one of a text file, an executable file, an audio file, a video file, and an audio-video file.

24. A method as set forth in claim 22 wherein the content includes one or more web pages containing at least a portion of the lesson.

25. A method as set forth in claim 19 wherein the method further comprises connecting the computer to the Internet, and wherein the act of receiving a computer-based game includes receiving the computer-based game at the computer via the Internet.

26. A method as set forth in claim 19 wherein the method further comprises connecting the computer to the Internet, and wherein the act of receiving a computer-based game includes receiving content from a web site via the Internet, the content including the game.

27. A method as set forth in claim 19 wherein the technique includes a process improvement technique.

28. A method as set forth in claim 19 wherein the technique includes the design for Six Sigma technique.

29. A method of learning a technique via a computer, the method comprising:
connecting the computer to a web site;
receiving content at the computer from the web site, the content including a lesson teaching at least an aspect of the technique;
executing the content at the computer;
learning the lesson;
receiving further content at the computer, the further content including a game to support the teachings of the lesson;
executing the further content at the computer; and
playing the game.

30. A method as set forth in claim 29 wherein the acts of receiving and executing the further content are after the acts of receiving and executing the content.

31. A method as set forth in claim 29 wherein the method further comprises connecting the computer to the Internet, and wherein connecting the computer to a web site includes contenting the computer to the web site via the Internet;

32. A method as set forth in claim 29 wherein the content includes at least one of a text file, an executable file, an audio file, a video file, and an audio-video file.

33. A method as set forth in claim 29 wherein the act of receiving content at the computer includes receiving one or more web pages containing at least a portion of the lesson.

34. A method as set forth in claim 29 wherein the technique includes a process improvement technique.

35. A method as set forth in claim 29 wherein the technique includes the design for Six Sigma technique.

36. A method of teaching a technique to a user, the method comprising:
teaching a lesson to a user, the lesson teaching at least an aspect of the technique;
providing a computer-base game to the user to be played by the user, the game supporting the teachings of the lesson and resulting in stored data when the user plays the game;
obtaining the data; and
analyzing the data.

37. A method as set forth in claim 36 wherein the act of teaching includes communicating a computer-based lesson to the user.

38. A method as set forth in claim 36 wherein the act of teaching includes communicating a computer-based lesson to the computer via the Internet.

39. A method as set forth in claim 38 wherein the method further comprises providing a server executing a web site, and wherein the act of communicating a computer-based lesson includes communicating content from the server to the computer, the content including the lesson.

40. A method as set forth in claim 36 and further comprising providing a defined scenario for the game to the user to be implemented with the game.

41. A method as set forth in claim 36 wherein the game includes customers and each customer has information associated with the customer, the information including thoughts of the customer and being included in the stored data.

42. A method as set forth in claim 41 wherein the information of each customer includes customer attributes.

43. A method as set forth in claim 36 and further comprising evaluating the user based on the analyzed data.

44. A method as set forth in claim 36 and further comprising teaching further lessons to the user based on the analyzed data.

45. A method of learning a technique, the method comprising:
receiving instruction including a lesson teaching at least an aspect of the technique;
receiving a scenario for a computer-based game that supports the teachings of the lesson; and
playing the game including the scenario.

46. A method as set forth in claim 45 wherein the act of receiving instruction includes receiving a computer-based lesson at the computer.

47. A method as set forth in claim 46 wherein the method further comprises connecting the computer to the Internet, and wherein the act of receiving a computer-based lesson includes receiving the computer-based lesson at the computer via the Internet.

48. A method as set forth in claim 46 wherein the method further comprises connecting the computer to the Internet, wherein the act of receiving a computer-based lesson includes receiving content from a web site via the Internet, the content including the lesson, and wherein learning the lesson on the computer includes executing the content.

49. A method as set forth in claim 45 and further comprising obtaining a computer-based game.

50. A method as set forth in claim 45 wherein playing the game results in stored data.

51. A method as set forth in claim 50 wherein the game includes customers and each customer has information associate with the customer, the information including thoughts of the customer and being included in the stored data.

52. A method as set forth in claim 51 wherein the information of each customer includes customer attributes.

53. A method as set forth in claim 50 and further comprising receiving an evaluation based on an analysis of the stored data.

54. A method as set forth in claim 50 and further comprising receiving further instruction including an additional lesson, wherein the further instruction is based on an analysis of the stored data.

55. A method as set forth in claim 51 and further comprising:
determining the voice of the customers;
measuring the output important to the customer;
translating the output into internal specifications;
determining a design based on the internal specifications;
while playing the game, implementing the design; and
evaluating the design based on an analysis of the obtained data.

56. A method of teaching a technique to a user, the method comprising:
providing a computer-based game to the user to be played by the user, the game resulting in stored data when the user plays the game;
obtaining the data;
analyzing the data;
creating a lesson based on the data, the lesson including at least an aspect of the technique; and
teaching the lesson.

57. Software adapted to be used by a computer having a processor and memory, the software comprising:
a computer-based game which is operable to generate game related data stored on the computer memory; and
a lesson for teaching a technique, the lesson including the steps of obtaining the game related data, analyzing the game related data and including content directed to at least an aspect of the technique using the analyzed data to teach the lesson.
